(19) United States
(12) Patent Application Publication
(10) Pub. No.: US 2009/0008967 A1
(43) Pub. Date: Jan. 8, 2009

(54) Method and Device For Controlling the Displacement Process For a Hood System

(75) Inventors: Michael Antreich, Germering (DE); Markus Gross, Raisting (DE); Christof Morscheit, Munich (DE); Ralf Weigel, Buchloe (DE); Hermann Kern, Mammendorf (DE)

Correspondence Address: DICKINSON WRIGHT PLLC, 1875 Eye Street, NW, Suite 1200, WASHINGTON, DC, 20006, US

(73) Assignee: WEBASTO AG, Stockdorf (DD)

(21) Appl. No.: 12/279,650

(22) PCT Filed: Feb. 6, 2007
(86) PCT No.: PCT/DE07/00232

§ 371 Date: Aug. 15, 2008

(30) Foreign Application Priority Data
Feb. 20, 2006 (DE) 10 2006 007 767.9

(51) Int. Cl. B60J 7/057

(52) U.S. Cl. 296/223

(57) ABSTRACT

The invention relates to a method and a device for controlling the displacement process of a hood system. According to the invention the following steps are provided: provision of a first number of position sensors (20-22,25,26) to determine the actual position of the hood system, the first number of position sensors being greater than a second number of position sensors which are required as a minimum for determining the position of the hood system, determination of a third number of functioning position sensors, from the first number of position sensors, comparison of the first number with the third number and movement of the hood system into a defined position so long as the third number is less than the first number.

The invention relates to a method and to a device for controlling the displacement process for a hood system, in particular a hood system for a cabriolet.

A system for opening and closing a folding hood or movable vehicle roof in a cabriolet, which system also has position sensors, is described, for example, in German patent application DE 102 01 871 A1.

Currently known vehicle roof systems which can be opened, called hood systems for short in the text which follows, have, in addition to the actual hood, at least one controllable drive and a component whose position can be adjusted. Depending on the response of at least one adjustable component, the hood of the hood system is thus automatically removed from a roof region, folded up or folded together from a closed state and transported into a storage space for an open state. This applies equally to folding roofs with material or plastic components (soft-tops) and to multi-part so-called hard-shell systems (hard-tops). In hard-shell systems, at least two hard shells are typically used to cover the passenger compartment. The associated mechanical connections, joints and drives for displacing the hood system also require a relatively large storage space. A hydraulic connection, in particular of the front-most shell, considerably reduces the number of mechanical components required.

As the hood system is unfolded, the purely mechanical components are displaced together with the hydraulic actuators at the same time. In the process, the hood system moves between a start position, in which the hood system is completely unfolded, and an end position, in which the hood system is fully accommodated in a storage space. Care should be taken here that the displacement takes place in accordance with a predefined control sequence, in order to prevent the individual shells being damaged by other shells or elements. In order to displace the individual elements of the hood system, the individual actuators therefore have to be activated and operated at predefined times and in a predetermined correct order. In order to be able to exactly determine these predefined times, a large number of position sensors are provided which are arranged in the region of the hood system of a cabriolet and which are designed to determine the position of the individual elements of the hood system when the hood system is opened and closed. The, for example analogous, position sensors can be arranged on the shells and the actuators and the drive systems, in order to determine the position of the individual elements as the hood system is unfolded or folded up. The position data, which is acquired in this way, about the individual shells in relation to one another and in relation to the body of the vehicle is used by a control apparatus to implement the control sequence. It is essential here for the acquired position data from the individual position sensors to be reliable.

Since malfunctioning of these position sensors can lead to damage to the hood system or to the body of the cabriolet, a larger number of position sensors than would be required at the minimum for the position determination operation are often used. This is referred to as a redundancy of position sensors. These redundant position sensors increase the reliability of position determination when the hood system is opened and closed. However, if one or more of the position sensors fails, the reliability of position determination is no longer completely ensured (despite redundancy), with the result that there is a risk of the hood system or the body of the cabriolet being damaged when the hood system is opened or closed.

Against this background, the invention is based on the object of providing improved and, in particular, more reliable position determination for a hood system of a motor vehicle.

According to the invention, this object is achieved by a method having the features of patent claim 1 and/or by a device having the features of patent claim 12.

Accordingly, provision is made of:

A method for controlling the displacement process for a hood system, comprising the steps of:
(a) providing a first number of position sensors for determining the current position of the hood system, with the first number of position sensors being greater than a second number of position sensors which are required at the minimum to determine the position of the hood system;
(b) determining a third number of functional position sensors from the first number of position sensors;
(c) comparing the first number with the third number;
(d) moving the hood system to a defined position if the third number is lower than the first number.

A device for controlling the displacement process for a hood system, in particular by means of a method according to the invention,
comprising actuators for moving the hood system;
comprising a first number of position sensors which are designed to determine a current position of the hood system, with the first number of position sensors being greater than a second number of position sensors which are required at the minimum to determine the position of the hood system;
comprising a checking device which checks whether a respective position sensor is functional and which determines a third number of functional position sensors;
comprising a comparison device which compares the first number with the third number; and
comprising a control device which actuates the actuators in such a way that the hood system moves to a defined position if the third number is lower than the first number.

The concept on which the present invention is based involves moving the hood system to a defined position when one or a few position sensors are defective. Displacement of the hood system to this defined position can also be achieved with the aid of the position sensors which are provided in a partially redundant manner. Damage to the hood by further displacement of the hood or the corresponding adjusting device, which displacement may no longer be controlled in a defined manner, is prevented as a result.

The position sensors used may be all sensors which are suitable and designed for determining the position and location of elements of the hood system, that is to say of the hood, of the drive and of the linkage. In this case, position determination may be optical, acoustic, mechanical, inductive, capacitive and the like.

Advantageous developments and refinements are the subject matter of the further subclaims or can be found in the description when considered together with the drawing.

In a typical refinement of the invention, the defined position denotes the end position of the hood system. In this case, the end position can denote an open (hard-shell roof, collapsible roof) or stretched (folding roof) state of the hood system, in which state the hood system is arranged above a passenger compartment. In addition or as an alternative, the end position can also denote a collapsed or folded-up state of the hood system, in which state the hood system is accommodated in an at least partially closed storage space, for example in the trunk or in a space which is provided specially for a collapsible or folding roof.

According to a refinement, the functional position sensors are determined by comparing signals from the position sensors with data from predefined specification tables.

In a development of the invention, actuators for displacing the hood system are provided, which actuators are operated until the hood system has been displaced into a predefined desired position, that is to say a position desired by the user. Actuators may be operated hydraulically, pneumatically and/or electrically. Actuators may also be motors of any kind.

In a refinement, the hood system remains in its current position and the actuators are not operated if the third number is lower than the second number. Since the ascertained third number of functional position sensors is lower than the second number of position sensors which is required to ensure correct functioning, the exact position of the hood system can no longer be determined in this case. The risk of damage would be too great in this case, with the result that displacement of the hood system is precluded. Displacement does not take place when indispensible position sensors, which are therefore necessarily required for position determination purposes and therefore cannot be replaced by redundant position sensors which may be present, fail. Therefore, there is no redundant replacement for these indispensable position sensors.

In a development, the position sensors are divided into priority classes. In this case, the division into priority classes is performed on the basis of the accuracy, the resolution, the quality of the measurement, the susceptibility to faults etc. of the position sensors. In this case, a current position of the hood system is preferably determined on the basis of an item of position information from a position sensor which has been given a higher priority and without taking into account a corresponding item of position information from a position sensor which has been given a lower priority if the first item of position information, which is determined by the position sensor which has been given a higher priority, is not the same as the corresponding second item of position information, which is determined by the position sensor which has been given a lower priority. The position signals from the various position sensors generally differ in significance or meaningfulness. Furthermore, the accuracy of individual position sensors may exceed the other position sensors. It is therefore advantageous to pay greater attention to these more accurate position sensors which have therefore been given a higher priority.

In a refinement of the invention, a mechanical model of the hood system is created. On the basis of the created mechanical model, the first item of position information is compared with the second item of position information using a mechanical model of the hood system. As a result, nonsensical signal combinations can already be excluded very early during position determination, as a result of which position determination is more reliable overall.

According to a preferred development, a position sensor is determined as being functional if the items of position information acquired by this position sensor match the items of position information acquired by the majority of the other position sensors. This development is based on the finding that one or more position sensors can have a defect which is not immediately clearly identifiable. However, this position sensor then generates items of position information which differ from the other position sensors and should advantageously not be taken into account for the position determination process. In a certain sense, this also results in validation of the different items of position information with one another. In contrast, it can be assumed that, given matching information from a plurality of position sensors, these position sensors are fully functional. Matching items of position information are to be understood as all items of position information being associated with the same position of the hood system. In contrast, it goes without saying that these items of position information may differ, for example in terms of their numerical values, since they are generated by different or differently arranged position sensors.

According to a development, at least one position sensor is designed to detect a distance, a change in distance, a length, a relative location, an angle, a change in angle, a contact connection and/or a locking.

The present invention is explained below with reference to the exemplary embodiments provided in the schematic figures of the drawing, in which:

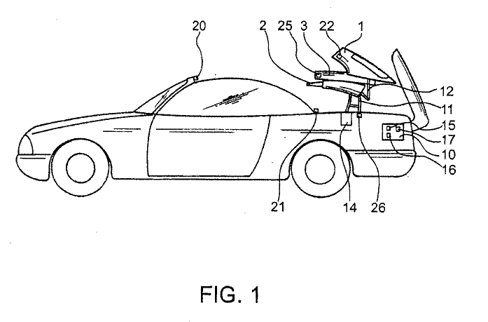

FIG. 1 shows a side view of a cabriolet with an embodiment of the device according to the invention; and

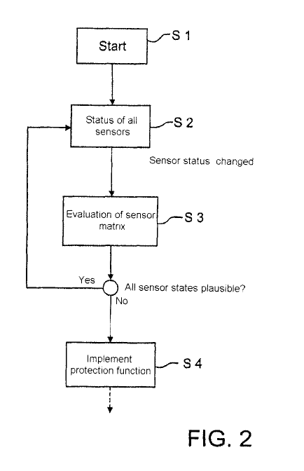

FIG. 2 shows an embodiment of the method according to the invention.

FIG. 1 shows a side view of a cabriolet whose trunk accommodates a hard-shell hood system. The hood system has a front-most shell 3, a middle shell 2 and a rear shell 1. A rear window can be integrated in the rear shell 1. A drive device 14 in the trunk operates a linkage with a main four-bar linkage 11. This linkage is connected to the middle shell 2 and to the rear shell 1 by means of a pivot lever 12. The middle shell 2 and the front shell 3 are connected to one another by means of a plurality of hydraulic actuators 13. The drive device 14 displaces the primary linkage 11, with the result that the three shells 1, 2, 3 are lifted out of the trunk. Starting from a specific position of the linkage 11 or of the hood system, the hydraulic actuators 13 are operated so that the front shell 3 is pushed forward. This critical position has to be reached with a very high degree of accuracy; there is typically only a tolerance of 2 mm here. Otherwise, the front shell 3 collides with one or both of the other shells 1, 2 during forward movement. To this end, a control device 10 controls the drive device 14 and the actuators 13 in accordance with a predefined schedule. In this case, actuation has to be performed between the various drive devices and the actuators 13 in accordance with this schedule in a synchronous manner.

The hood system has a large number of sensors 20-26. The sensors 20, 21 are arranged on the vehicle body, the sensors 22, 25 are arranged on the shells, and the sensors 26 are arranged on the linkage or the drive device. The sensors comprise displacement or position sensors 25, 26 which measure an angle, a change in angle, a displacement or a distance. Furthermore, the sensors 20, 21, 22 may also be in the form of contact sensors which detect shells being supported at specific points. The sensors are connected to an evaluation device 15 for transmitting the signals. Transmission may be performed in a line-bound or wire-free manner. The evaluation device 15 is expediently integrated in the control device 10. The function of all the described sensors 20-26 is to determine the position of the hood and its displaceable components; said sensors are therefore also called position sensors.

The hood is displaced, that is to say unfolded or folded, along a predetermined path by a drive device and one or more actuators 13. To this end, the position signals from a large number of sensors 20-26 are permanently evaluated. The position of the hood at any time is determined from the position signals. This includes the individual location of the individual shells 1, 2, 3 in relation to the vehicle and in relation to one another. To this end, the sensors determine the position, the angle, the speed and/or contact with other components, for example the front windshield. The control system 10 can determine the control instructions for the actuators and the drive device, in order to displace these synchronously with respect to one another, using the present position.

If an individual sensor or a few sensors are damaged, an emergency operation routine with which the hood is closed over the passenger compartment should be ensured. In the exemplary embodiment shown in FIG. 2, the status of all the sensors is first checked by a checking device 17 (S2). Electronic failure of a sensor can be identified centrally by the control device 10 or, under certain circumstances, identified by the sensor itself and transmitted to the control device. Only the position signals whose associated sensors are functional are used for emergency operation. The position signals are evaluated by an evaluation device. A kinematic model of the hood system can be used for this purpose. The items of position information acquired in the process are compared with one another (S3). In a next step (S3), the items of position information are checked for plausibility. From this, conclusions can be drawn about the presence of a defective sensor. If all the position information corresponds, the hood remains fully functional. In the opposite case, a protection function is initiated (S4). In this case, there is at least one defective sensor.

If a comparison device 16 establishes that the number of functional sensors is above a minimum number, the hood is closed, that is to say moved to the end position over the passenger compartment.

Many sensors are of redundant design; for an emergency operation routine, these sensors can be temporarily dispensed with. No redundant replacement is provided for other sensors. However, the position information from said sensors can be drawn from the position information from other sensors. For example, a contact sensor and a locking sensor are arranged close to the windshield. If the locking sensor signals locking, it can be assumed that the contact sensor would also have to signal contact. It is therefore possible, in principle, to unambiguously determine the position of the hood even when a contact sensor is defective.

The ability of a sensor to function can be established on the basis of specifications of the associated position signals or by checking signals.

The sensors and the associated position signals can also be checked for plausibility in relation to one another. Therefore, for example, a contact sensor of the storage space can signal that said storage space is closed. At the same time, a position sensor of a shell signals that the shell is outside the storage space. A configuration such as this is not possible on account of the mechanical design of the hood. Such a contradiction can therefore be determined on the basis of a mechanical model of the hood system. Furthermore, it is also possible to create logic combination tables which reveal such contradictions. The corresponding truth table would, for example, contain an entry that contact connection of the end-point sensor 20 is not possible at the same time as the storage space is closed.

Individual sensors and their position signals can advantageously be assigned a higher priority. In the case of the preceding contradictions, these priorities can be used to resolve the contradictions. In this case, the position signal with the higher priority in each case is used to determine the position and the position signal with the lower priority is ignored.

Although the present invention has been described with reference to a preferred exemplary embodiment, it is not restricted to said exemplary embodiment. Rather, the method can likewise be used generally to actuate the hood system, and not only for emergency operation of the hood system.

### LIST OF REFERENCE SYMBOLS

1, 2, 3 Shells
10 Control device
11, 12 Linkage
13 Actuators
14 Drive device
15 Evaluation device
16 Comparison device
17 Checking device
20-26 Sensors
S1-S4 Method steps

1. A method for controlling the displacement process for a hood system, comprising the steps of:
(a) providing a first number of position sensors for determining the current position of the hood system, with the first number of position sensors being greater than a second number of position sensors which are required at the minimum to determine the position of the hood system;
(b) determining a third number of functional position sensors from the first number of position sensors;
(c) comparing the first number with the third number;
(d) moving the hood system to a defined position if the third number is lower than the first number.

2. The method of claim 1, characterized in that the defined position denotes the end position of the hood system.

3. The method of claim 1, characterized in that the end position denotes an open or stretched state of the hood system, in which state the hood system is arranged above a passenger compartment, and/or in that the end position denotes a collapsed or folded-up state of the hood system, in which state the hood system is accommodated in an at least partially closed storage space.

4. The method of claim 1, characterized in that the functional position sensors are determined by comparing signals from the position sensors with data from predefined specification tables.

5. The method of claim 1, characterized in that actuators for displacing the hood system are provided, which actuators are operated until the hood system has been displaced into a predefined desired position.

6. The method as of claim 5, characterized in that the hood system remains in its present position and the actuators are not operated if the third number is lower than the second number.

7. The method of claim 1, characterized in that the position sensors are divided into priority classes.

8. The method of claim 7, characterized in that a current position of the hood system is determined on the basis of an item of position information from a position sensor which has been given a higher priority and without taking into account a corresponding item of position information from a position sensor which has been given a lower priority if the first item of position information, which is determined by the position sensor which has been given a higher priority, is not the same as the corresponding second item of position information which is determined by the position sensor which has been given a lower priority.

9. The method of claim 8, characterized in that a mechanical model of the hood system is created, and in that the first item of position information is compared with the second item of position information using the mechanical model.

10. The method of claim 1, characterized in that a position sensor is classified as being functional if the items of position information acquired by this position sensor match the items of position information acquired by the majority of the other position sensors.

11. The method, of claim 1 characterized in that at least one position sensor is designed to detect a distance, a change in distance, a length, a relative location, an angle, a change in angle, a contact connection and/or a locking.

12. A device for controlling the displacement process for a hood system, in particular by means of the method of claim 1, comprising:
actuators for moving the hood system;
a first number of position sensors which are designed to determine a current position of the hood system, with the first number of position sensors being greater than a second number of position sensors which are required at the minimum to determine the position of the hood system;
a checking device which checks whether a respective position sensor is functional and which determines a third number of functional position sensors;
a comparison device which compares the first number with the third number; and
a control device) which actuates the actuators in such a way that the hood system moves to a defined position if the third number is lower than the first number.
